(19) United States
(12) Patent Application Publication
(10) Pub. No.: US 2022/0164669 A1
(43) Pub. Date: May 26, 2022

(54) AUTOMATIC MACHINE LEARNING POLICY NETWORK FOR PARAMETRIC BINARY NEURAL NETWORKS

(71) Applicant: Intel Corporation, Santa Clara, CA (US)

(72) Inventors: Anbang Yao, Beijing (CN); Aojun Zhou, Beijing (CN); Dawei Sun, Beijing (CN); Dian Gu, Shanghai (CN); Yurong Chen, Beijing (CN)

(73) Assignee: Intel Corporation, Santa Clara, CA (US)

(21) Appl. No.: 17/442,111

(22) PCT Filed: Jun. 5, 2019
(86) PCT No.: PCT/CN2019/090133

§ 371 Date: Sep. 22, 2021

(51) Int. Cl. G06N 3/08; G06N 3/04; G06N 3/063

(52) U.S. Cl. CPC G06N 3/084; G06N 3/063; G06N 3/0454

(57) ABSTRACT

Systems, methods, apparatuses, and computer program products to receive a plurality of binary weight values for a binary neural network sampled from a policy neural network comprising a posterior distribution conditioned on a theta value. An error of a forward propagation of the binary neural network may be determined based on a training data and the received plurality of binary weight values. A respective gradient value may be computed for the plurality of binary weight values based on a backward propagation of the binary neural network. The theta value for the posterior distribution may be updated using reward values computed based on the gradient values, the plurality of binary weight values, and a scaling factor.

### BACKGROUND

Deep neural networks (DNNs) are tools for solving complex problems across a wide range of domains such as computer vision, image recognition, image processing, speech processing, natural language processing, language translation, and autonomous vehicles. Recent improvements have caused the architecture of DNNs to become significantly deeper and more complex. As such, the intensive storage, computation, and energy costs of top-performing DNN models prohibit their deployment on resource-constrained devices (e.g., client devices, edge devices, etc.) for real-time applications.

Binary neural networks may use binary values for weights and/or activations in the neural network. Doing so may provide much smaller storage requirements (e.g., one bit vs. 32-bit floating point values) and cheaper bit-wise operations over full-precision implementations. However, by virtue of lower precision binary values, binary neural networks are less accurate than full-precision implementations. Furthermore, conventional approaches to train binary neural networks are not flexible, as conventional solutions only output a single binary neural network instance with one round of conventional time-intensive training. Further still, conventional training of binary neural networks adopt inefficient two-stage training, which requires the pre-training of a full-precision 32-bit model, then training a binary version from the pre-trained full-precision 32-bit model.

### BRIEF DESCRIPTION OF THE DRAWINGS

FIG. 1 illustrates an embodiment of a system.

FIG. 2 illustrates an example of an automatic machine learning policy network for a parametric binary neural network.

FIG. 3 illustrates an example of training an automatic machine learning policy network.

FIG. 4 illustrates an embodiment of a first logic flow.

FIG. 5 illustrates an embodiment of a second logic flow.

FIG. 6 illustrates an embodiment of a third logic flow.

FIG. 7 illustrates an embodiment of a storage medium

FIG. 8 illustrates an embodiment of a system.

### DETAILED DESCRIPTION

Embodiments disclosed herein provide automatic machine learning (ML) policy networks (also referred to as “policy agents” or “policy networks” herein) for parametric binary neural networks. Generally, a policy network may approximate the posterior distribution of binary weights for one or more binary neural networks without requiring full-precision (e.g., 32-bit floating point) reference values. One or more binary neural networks may sample the posterior distribution of binary weights without requiring the application of scaling factors (e.g., layer-wise and/or filter-wise scaling factors) conventionally required to enhance the accuracy of binary neural networks. A policy network may generally provide multiple binary weight sharing designs. For example, the policy network may provide layer-wise weight sharing, filter-wise weight sharing, and/or kernel-wise weight sharing. The policy network may be trained using a four-stage reinforcement learning algorithm. Advantageously, doing so facilitates sampling of different binary weight instances to train a given binary neural network architecture from the trained policy network, where the architecture (which defines how the parameters of the neural network are stacked in a hierarchical topology) of the binary neural network is known before training. By providing enhanced accuracy, different instances of binary neural networks may support hardware-specialized and/or user-specific applications. Stated differently, different users and/or devices may each have dedicated binary neural networks that share the same architecture while providing similar recognition accuracy. Furthermore, the binary neural networks and the policy network provide enhanced precision with reduced storage, energy, and processing resource requirements relative to full-precision implementations.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

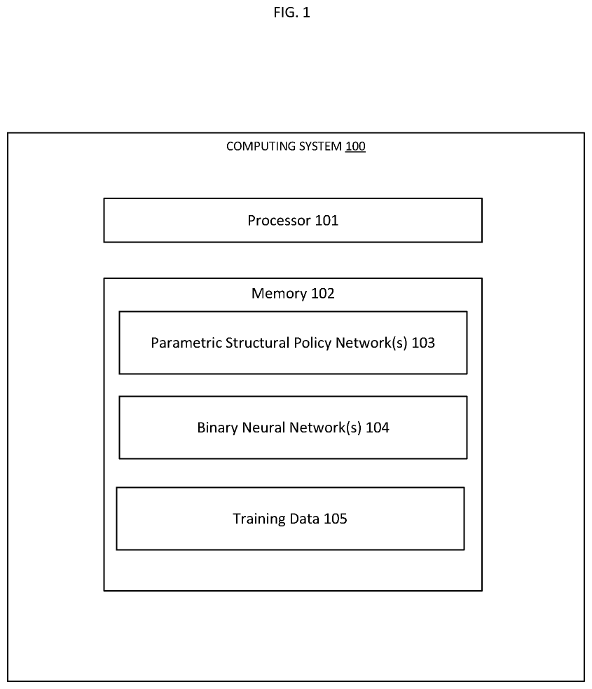

FIG. 1 illustrates an embodiment of a computing system 100 that provides automatic machine learning policy networks for parametric binary neural networks. The computing system 100 may be any type of computing system, such as a server, workstation, laptop, or virtualized computing system. For example, the system 100 may be an embedded system such as a deep learning accelerator card, a processor with deep learning acceleration, a neural compute stick, or the like. In some examples, the system 100 comprises a System on a Chip (SoC) and, in other embodiments, the system 100 includes a printed circuit board or a chip package with two or more discrete components. The system 100 includes a processor 101 and a memory 102. The configuration of the computing system 100 depicted in FIG. 1 should not be considered limiting of the disclosure, as the disclosure is applicable to other configurations. The processor 101 is representative of any type of computer processor circuits, such as, central processing units, graphics processing units, or otherwise any processing unit. Further, one or more of the processors may include multiple processors, a multi-threaded processor, a multi-core processor (whether the multiple cores coexist on the same or separate dies), and/or a multi-processor architecture of some other variety by which multiple physically separate processors are in some way linked.

The memory 102 is representative of any type of information storage technology, including volatile technologies requiring the uninterrupted provision of electric power, and including technologies entailing the use of machine-readable storage media that may or may not be removable. Thus, the memory 102 may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although the memory 102 is depicted as a single block, the memory 102 may include multiple storage devices that may be based on differing storage technologies. Thus, for example, the memory 102 may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid-state memory devices enabling relatively quick access to programs and/or data (e.g., SRAM or DRAM). It should also be noted that the memory 102 may be made up of multiple storage components based on identical storage technology, but which may be maintained separately as a result of specialization in use (e.g., some DRAM devices employed as a main storage while other DRAM devices employed as a distinct frame buffer of a graphics controller).

As shown, the memory 102 includes one or more parametric structural policy network(s) 103, one or more binary neural network(s) 104, and a data store of training data 105. Although depicted as residing in the memory 102, the policy networks 103, binary neural networks (BNN) 104, and/or training data 105 may be implemented as hardware, software, and/or a combination of hardware and software. Furthermore, when embodied at least partly in software, the policy networks 103, binary neural networks 104, and/or training data 105 may be stored in other types of storage coupled to the computing system 100.

Generally, a policy network 103 is a configured to provide binary weight values (e.g., 1-bit values such as “−1” and/or “1”) for one or more BNNs 104 conditioned on posterior distributions that can be trained using a four-stage training phase that leverages reinforcement learning. The policy network 103 may provide one or more weight sharing designs. The weight sharing designs may include weights shared by neural network kernels, weight shared by neural network filters, and weights shared by neural network layers. For example, when weights are shared by layers of a neural network, each weight for a given parameter in the layer is sampled from a single posterior distribution. In such an example, if a layer of the network includes 100 parameters, weight values for each of the 100 parameters of the layer is sampled from a single posterior distribution (e.g., generated based on a posterior distribution function) for the layer. Furthermore, if 5 layers exist in the neural network, 5 posterior distributions may exist in the layer-sharing design (e.g., 1 posterior distribution for each layer). In filter sharing, weight values for the parameters of a given filter of the neural network are sampled from a posterior distribution for the filter, where each filter in the neural network is associated with a respective posterior distribution. In kernel sharing, weight values for the parameters of a given kernel of the neural network are sampled from a posterior distribution for the kernel, where each kernel in the neural network is associated with a respective posterior distribution. Doing so reduces the number of distributions required to train binary neural networks.

Once trained, binary weight values for one or more of the binary neural networks 104 may sampled by the policy network 103. The BNNs 104 are representative of neural networks that use binary (e.g., 1-bit) values for weights and/or activations. In one embodiment, the weight and/or activation values of the BNNs 104 are forced to be values of “−1” and/or “1”. Example neural networks include, but are not limited to, Deep Neural Networks (DNNs) such as convolutional neural networks (CNNs), recurrent neural networks (RNNs), and the like. A neural network generally implements dynamic programing to determine and solve for an approximated value function. A neural network is formed of a cascade of multiple layers of nonlinear processing units for feature extraction and transformation. Generally, each successive layer of a neural network uses the output from the previous layer as input. A neural network may generally include an input layer, an output layer, and multiple hidden layers. In some embodiments, the policy network 103 includes an input layer, a plurality of hidden layers, and an output layer. The hidden layers of a neural network may include convolutional layers, pooling layers, fully connected layers, SoftMax layers, and/or normalization layers. In one embodiment, the plurality of hidden layers comprise three hidden layers (e.g., a count of the hidden layers comprises three hidden layers). In some embodiments, the neurons of the layers of the policy network 103 are not fully connected. Instead, in such embodiments, the input and/or output connections of the neurons of each layer may be separated into groups, where each group is fully connected.

Generally, a neural network includes two processing phases, a training phase and an inference phase. During the training process, a deep learning expert will typically architect the network, establishing the number of layers in the network, the operation performed by each layer, and the connectivity between layers. Many layers have parameters, which may be referred to as weights, that determine exact computation performed by the layer. The objective of the training process is to learn the weights, usually via a stochastic gradient descent-based excursion through the space of weights. Once the training process is complete, inference based on the trained neural network (e.g., image analysis, image and/or video encoding, image and/or video decoding, face detection, character recognition, speech recognition, etc.) typically employs a forward-propagation calculation for input data to generate output data.

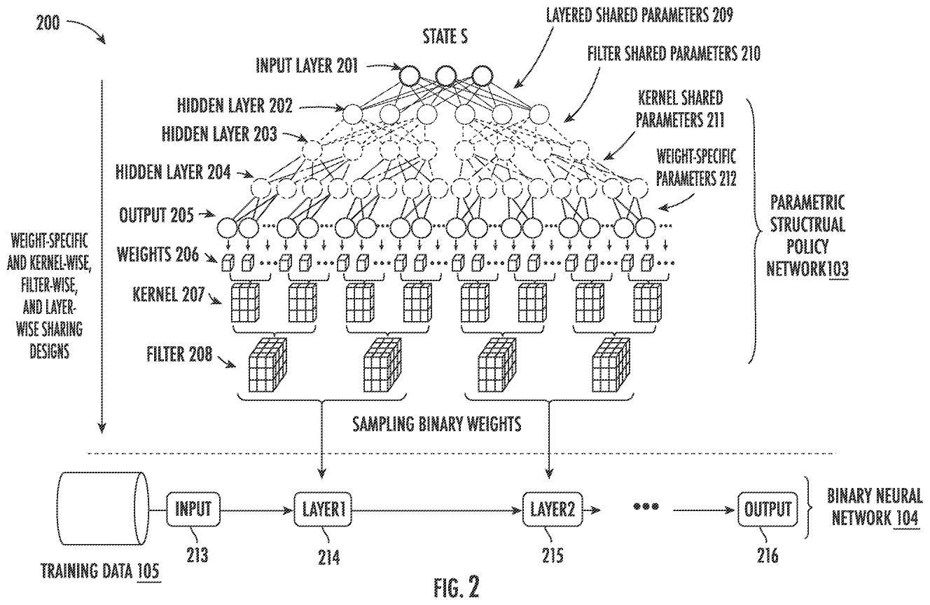

FIG. 2 is a schematic 200 illustrating components of the system 100 in greater detail. More specifically, FIG. 2 depicts components of an example policy network 103 and an example binary neural network 104. As stated, the binary neural network 104 may be configured to perform any number and type of recognition tasks. The use of image recognition as an example recognition task herein should not be considered limiting of the disclosure. In such an image recognition example, the training data 105 may comprise a plurality of labeled images. For example, an image in the training data 105 depicting a cat may be tagged with a label indicating that the image depicts a cat, while another image in the training data 105 depicting a human may be tagged with a label indicating that the image depicts a human

As shown in FIG. 2, the BNN 104 includes layers 213-216, including two hidden layers 214-215. Although two hidden layers of the BNN 104 are depicted, the BNN 104 may have any number of hidden layers. Generally, the weights of the layers 213-216 of the BNN 104 may be forced to be values of either “−1” or “1”. However, as shown, the weights of the hidden layers 213-214 are sampled from the policy network 103.

As used herein, the architecture of the BNN 104 may represented by “f” and the target training data 105 may be represented as “D(X,Y)”, where X corresponds to one or more images in the training data 105 and Y corresponds to labels applied to the images. The binary weights of the BNN 104 may be referred to as “W”, and may be sampled from the posterior distribution function defined by P(W|X,Y). In some embodiments, W may be conditioned on a parameter θ of the policy network 103, as defined by the following Equation 1:

$$P ( W \vert X , Y ) = {P}_{θ} ( w ) . \qquad Equation 1$$

In Equation 1, “w” corresponds to the weights of the BNN 104. Therefore, embodiments disclosed herein may formulate and approximate the posterior distribution P(W|X, Y) with P(w|θ) conditioned on θ without requiring any prior formulations (e.g., the initial values of θ may be randomly generated using a Bernoulli distribution). Once the posterior distribution P(W|X, Y) is estimated, the binary values of the posterior distribution P(W|X, Y) may be sampled by one or more instances of a BNN 104. Stated differently, a function for the posterior distribution may return binary values P(W|X, Y) to the BNN 104.

As shown in FIG. 2, a state “s” is the input to an input layer 201 of the policy network 103. The state “s” may be the current state of the policy network 103 (including any weights, posterior distributions, and/or θ values). The policy network 103 further includes hidden layers 202-204 and an output layer 205. The parameters of the policy network 103 may generally include one or more θ values and the weights of the hidden layers 202-204 (each not pictured for clarity). In some embodiments, the θ values and/or weights of the hidden layers 202-204 are not binary values, but instead may be full precision values (e.g., FP32 values). Illustratively, one or more binary weights 206, one or more kernels 207 of binary weights, and one or more filters 208 of binary weights may be sampled by a BNN 104. As illustrated, the connections between the layers of the policy network 103 provide binary layer shared parameters 209, binary filter shared parameters 210, binary kernel shared parameters 211, and binary weight-specific parameters 212. As shown, the layers 201-205 of the policy network 103 are not fully connected (e.g., each neuron of a given layer is not connected to each neuron of the next layer).

As stated, the policy network 103 may provide weight-specific sharing, kernel sharing, filter sharing, and layer sharing designs for binary values that can be sampled by a given BNN 104. The architecture of a BNN 104 (e.g., how the parameters of the BNN 104 are stacked in a hierarchical topology) may be known before training. Generally, each layer of a neural network may have one or more filters, each filter may have one or more kernels, and each kernel may have one or more weights. In weight specific sharing, each weight 206 (e.g., a binary value for a parameter) of a given BNN 104 is sampled from a respective posterior distribution of the policy network 103 (e.g., weight shared parameters 212) conditioned on a respective θ value. Therefore, for example, for a neural network that includes 500 parameters, the policy network 103 may include 500 distributions conditioned on a respective θ value (e.g., 500 distributions conditioned on a distinct θ value). Therefore, for example, the binary values for each parameter in the right-most kernel 207 in FIG. 2 may be conditioned on a posterior distribution for the right-most kernel 207 that is conditioned on a θ value. In kernel sharing, the binary weight values for a given kernel of the BNN 104 are sampled from a posterior distribution (e.g., kernel shared parameters 211) for in the policy network 103 (e.g., one or more kernels 207). In filter sharing, the binary weight values for a given filter of the BNN 104 are sampled from a posterior distribution (e.g., filter shared parameters 210) for a filter (e.g., one or more of the filters 208) in the policy network 103. Therefore, for example, the binary values for each parameter in the left-most filter 208 in FIG. 2 may be conditioned on a posterior distribution for the left-most filter 208 in the policy network that is conditioned on a θ value. In layer sharing, the binary weight values for each parameter in the layer of a BNN 104 (e.g., the layers 214-215) are sampled from a posterior distribution for the layer in the policy network 103 that is conditioned on a θ value. Therefore, for example, each parameter in layer 214 of BNN 104 may be sampled from a posterior distribution for the layer that is conditioned on a θ value in the policy network 103. Similarly, the values for layer 215 of BNN 104 may be sampled from a posterior distribution for the layer in the policy network 103 that is conditioned on a respective θ value.

Generally, a BNN 104 denoted by “f” may have “L” layers. In such an example, for a convolutional layer indexed by l, 1≤l≤L, the binary weight set is an O×I×K×K tensor, where O is an output channel number, I is an input channel number, and K is the spatial kernel size. Continuing with this example, every group of K×K weights may be referred to as a kernel, every group of I×K×K weights may be referred to as a filter and every group of O×I×K×K weights may be referred to as a layer. By treating every weight in a kernel as a single dimension, a given weight may be indexed as wₗᵢₒₖ, where 1≤l≤L, 1≤i≤l, 1≤o≤O and 1≤k≤K².

The policy network 103 provides a policy network for determining θ values using the shared parameters 209-212. As stated, the input to the policy network 103 is the state “s”, which may correspond to the current state of the binary weight values of the policy network 103. The hidden layer 202 may be referred to as h₁, the hidden layer 203 may be referred to as h₂, and the hidden layer 204 may be referred to as h₃. The layer shared parameters 209 may be referred to as θ¹ₗ, the filter shared parameters 210 may be referred to as θ²ₗᵢ, the kernel shared parameters 211 may be referred to as θ³ₗᵢₒ, and the weight-specific parameters 212 may be referred to as θ⁴ₗᵢₒₖ.

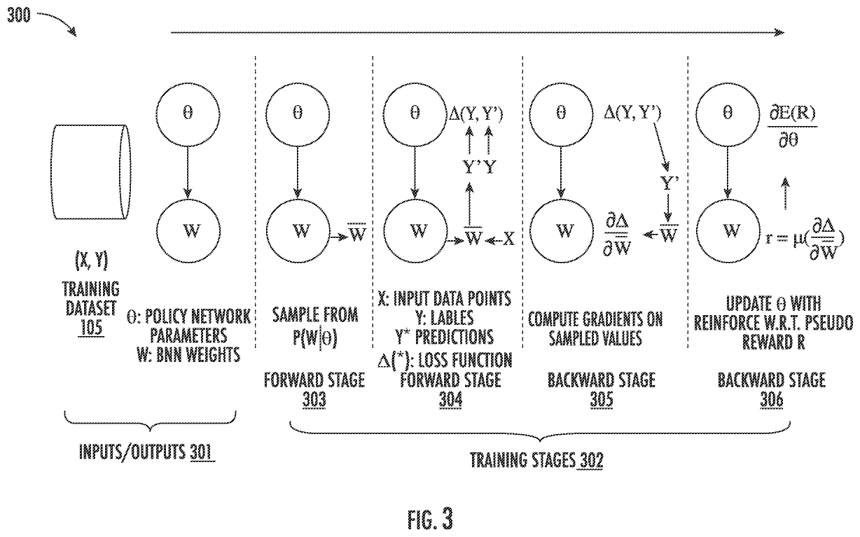

FIG. 3 is a schematic 300 depicting a four-stage training process. More specifically, the training may include at least the training of the θ values in the policy network 103, which can then be used to sample binary weights for one or more BNNs 104. As shown, an input/output stage 301 defines one or more images of training data 105 as input to the input layer 213 of the BNN 104. As stated, the policy network 103 may be sampled to provide binary weights for the BNN 104. However, the policy network 103 may be conditioned on one or more posterior distributions defined by a respective θ value. In embodiments where sharing is performed, the shared weights are conditioned on a posterior distribution (e.g., for a layer, filter, and/or kernel) that has a respective θ value. The training stages 302 depicted in FIG. 3 include a first forward stage 303, a second forward stage 304, a first backward stage 305, and a second backward stage 306.

In the first forward stage 303, binary weight values w̅ for the BNN 104 are sampled from the current posterior distribution P(w|θ) of the policy network 103. By denoting ƒ(*; θ) as a probabilistic sampling process, values for layer-wise sharing (e.g., the layer shared parameters 209) may be sampled from the posterior distribution defined by the following Equation 2:

$${h}_{l}^{1} = f ( s ; {θ}_{l}^{1} ) . \qquad Equation 2$$

Therefore, as shown in Equation 2, the layer-shared parameters are conditioned at least in part on the state “s” of the policy network 103 and θ. To sample values for the layer shared parameters 209, the BNN 104 and/or policy network 103 may apply Equation 2. As stated, a respective posterior distribution defined by Equation 2 may be applied for each layer in the policy network 103. The filter-wise sharing parameters (e.g., the filter shared parameters 210) may be sampled from the posterior distribution defined by the following Equation 3:

$${h}_{l i}^{2} = f ( {h}_{l}^{1} ; {θ}_{l i}^{2} ) . \qquad Equation 3$$

As shown in Equation 3, the filter shared parameters 210 are conditioned at least in part on the layer shared parameters 209. To sample values for the filter shared parameters 210, the BNN 104 and/or policy network 103 may apply Equation 3. As stated, a respective posterior distribution defined by Equation 3 may be applied for each filter in the policy network 103. The kernel-wise sharing (e.g., the kernel shared parameters 211) may be sampled from the posterior distribution defined by the following Equation 4:

$${h}_{l i o}^{3} = f ( {h}_{l i}^{2} ; {θ}_{l i o}^{3} ) . \qquad Equation 4$$

As shown in Equation 4, the kernel shared parameters 211 are conditioned at least in part on the filter shared parameters 210. To sample values for the kernel shared parameters 211, the BNN 104 and/or policy network 103 may apply Equation 4. As stated, a respective posterior distribution defined by Equation 4 may be applied for each kernel in the policy network 103. Equation 5 may correspond to a weight-specific probabilistic output pₗᵢₒₖ:

$${p}_{l i o k} = f ( {h}_{l i o}^{3} ; {θ}_{l i o k}^{4} ) . \qquad Equation 5$$

In Equation 5, the value of pₗᵢₒₖ is a weight-specific probabilistic output that characterizes a policy. Equation 6 below may be used to compute sampled weights that are returned to the BNN 104 in the first forward stage 303:

$$\{ \begin{matrix}P ( {\overline{w}}_{l i o k} = + 1 ) = {p}_{liok} \\ P {\overline{( w}}_{l i o k} = - 1 ) = 1 - {p}_{liok}\end{matrix} . \qquad Equation 6$$

Following the policies in Equations 2-6, binary weight sampling is performed in the first forward stage 303 to generate different binary weights connected by different sharing designs. To illustrate the parameter sharing mechanism, two example weights wₗᵢₒₖ₁ and wₗᵢₒₖ₂ may reside in the same kernel (e.g., one of the kernels 207 depicted in FIG. 2). These weights wₗᵢₒₖ₁ and wₗᵢₒₖ₂ may be sampled according to pₗᵢₒₖ₁ and pₗᵢₒₖ₂, where pₗᵢₒₖ₁ and pₗᵢₒₖ₂ are computed according to the following Equations 7 and 8:

$$\begin{matrix}{p}_{l i o k 1} = f ( f ( f ( f ( s ; {θ}_{l}^{1} ) ; {θ}_{l i}^{2} ) ; {θ}_{l i o}^{3} ) ; {θ}_{l i o k 1}^{4} ) . & Equation 7 \\ {p}_{l i o k 2} = f ( f ( f ( f ( s ; {θ}_{l}^{1} ) ; {θ}_{l i}^{2} ) ; {θ}_{l i o}^{3} ) ; {θ}_{l i o k 2}^{4} ) . & Equation 8\end{matrix}$$

Therefore, as shown in Equations 7 and 8, the sampled weight values include dependencies between the layer shared parameters 209, the filter shared parameters 210, and the kernel shared parameters 211. Such dependencies may be imparted to the BNN 104 when binary weight values are sampled from the policy network 103.

In the second forward training stage 304, a forward propagation is performed by the BNN 104 using a batch of training data 105 (e.g., a one or more images selected from the training data 105) denoted as X. Stated differently, in the second forward stage 304, the BNN 104 analyzes one or more images from the training data 105 to produce an output. The output may reflect a prediction by the BNN 104 of what is depicted in the training image (e.g., a human, dog, cat, the character “E”, the character “2”, etc.). This output may be denoted as Y*, where Y is denoted as the label of the image (e.g., the label indicating a cat is depicted in the training image). Because the BNN 104 may not generate a correct output (e.g., determining the image of a cat depicts a dog), an error may be determined based on the second forward stage 304. The error, or cross entropy metric, may be defined as Δ(Y*, Y), where Δ is the loss function.

In the first backward stage 305, one or more gradients

$$\frac{\partial Δ}{\partial \overline{w}}$$

are computed with respect to the binary weight values w̅ sampled in the first forward stage 303. In the second backward stage 306, the θ values of the policy network 103 are updated. However, because

$$\frac{\partial \overline{w}}{\partial θ}$$

cannot be trivially evaluated, embodiments disclosed herein update the θ values of the policy network 103 using a reinforcement learning algorithm that provides pseudo reward values r denoted as

$$μ ( \frac{\partial \overline{w}}{\partial θ} ) .$$

In one embodiment, the following Equations 9-10 may be used to compute the reward values r:

$$\begin{matrix}{g}_{l i o k} = \frac{\partial Δ}{\partial {\overline{w}}_{l i o k}} . & Equation 9 \\ {r}_{l i o k} = μ ( {g}_{l i o k} ) = - β \times {g}_{liok} \times {\overline{w}}_{l i o k} . & Equation 10\end{matrix}$$

In Equation 10, β is the scaling factor used to compute the reward value rₗᵢₒₖ. Therefore, the reward value rₗᵢₒₖis based on the gradient for the current weight, the current weight, and the scaling factor. In one embodiment, the reinforcement algorithm to update the values of θ is based on the following Equation 11:

$$J ( θ ) {\sum }_{l , i , o , k} {E}_{P ( {w}_{liok \vert θ} )} {r}_{l i o k} . \qquad Equation 11$$

Generally, Equation 11 may compute an expected reward value. In one embodiment, an unbiased estimator according to Equation 12 may be applied as part of the reinforcement algorithm:

$$∇ J ( θ ) {\sum }_{l , i , 0 , k} ( ∇ θ log P ( {\overline{w}}_{l i o k} \vert s , θ ) \times {r}_{l i o k} ) . \qquad Equation l2$$

Once the θ parameters of the policy network 103 are updated, the sampled weights w̅ are discarded and resampled using the updated θ parameters of the policy network 103. Using the updated θ parameters of the policy network 103 may allow the BNN 104 to improve accuracy in runtime operations. The four-stage training depicted in FIG. 3 may generally be repeated any number of times.

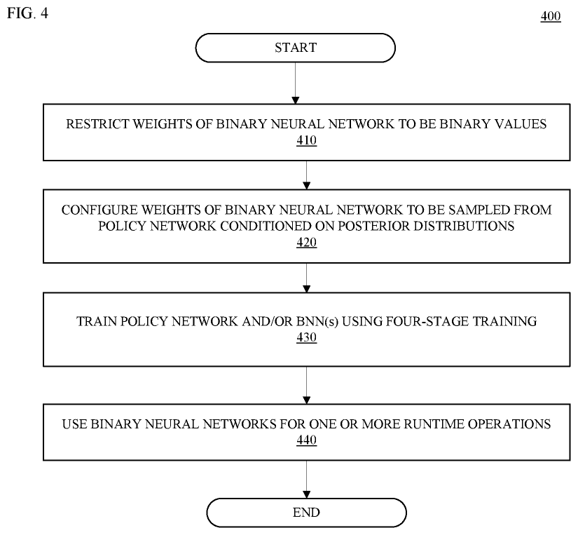

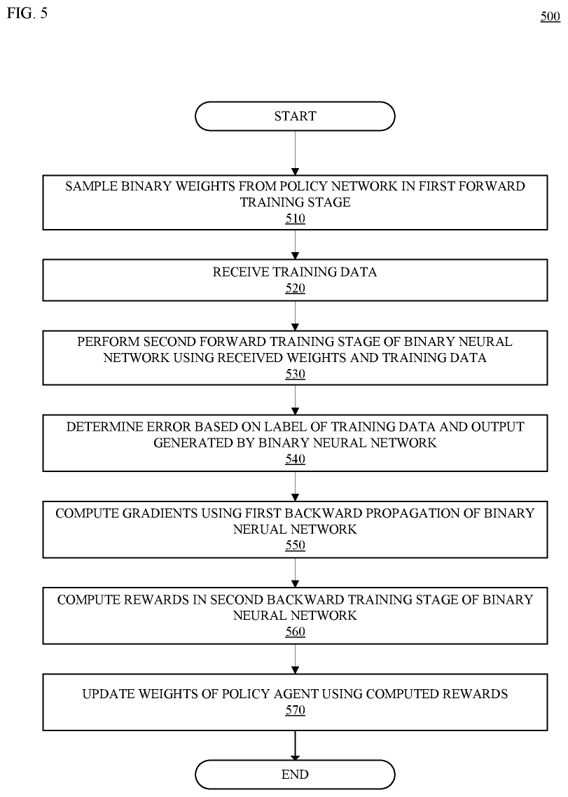

FIG. 4 illustrates an embodiment of a logic flow 400. The logic flow 400 may be representative of some or all of the operations executed by one or more embodiments described herein. For example, the logic flow 400 may be representative of some or all of the operations to provide an automatic machine learning policy network for a parametric binary neural network. Embodiments are not limited in this context. As shown, at block 410, where the weights of one or more binary neural networks 104 are restricted to be binary values. For example, the weights of each BNN 104 may be values of “−1” or “1”. The activation weights of each BNN 104 may further be restricted to binary values. Furthermore, the architecture (e.g., the hierarchical model) of the BNN 104 may be received as input. At block 420, the weights of the binary neural networks 104 are configured to be sampled from the policy network 103. The policy network 103 may include theta (θ) values for a plurality of posterior distributions. At block 430, the policy network 103 and/or the BNN(s) 104 may be trained using the four-stage training process described above and with reference to FIG. 5 below. At block 440, one or more binary neural networks 104 may be used to perform one or more runtime operations. For example, the binary neural networks 104 may use the binary weights sampled from the policy network 103 for image processing (e.g., identifying objects in images), speech processing, signal processing, etc.

FIG. 5 illustrates an embodiment of a logic flow 500. The logic flow 500 may be representative of some or all of the operations executed by one or more embodiments described herein. For example, the logic flow 500 may be implemented to train the policy network 103. Embodiments are not limited in this context.

As shown, at block 510, binary weight values may be sampled from the policy network 103 in a first forward training stage. As stated, the weight values are sampled according to a posterior distribution that is conditioned on one or more θ values. The binary weight values may include weight-specific binary values, kernel-shared binary values, filter-shared binary values, and layer-shared binary values. Therefore, for example, weight values one or more layers for the BNN 104 may be sampled from a layer-wise sharing structure provided by the policy network 103. At block 520, one or more batches of training data 105 are received. The training data 105 may be labeled, e.g., labeled images, labeled speech samples, etc. At block 530, a second forward training stage is performed using the weight values sampled at block 510 and the training data received at block 520. Generally, in the second forward training stage, the binary neural network 104 processes the training data to generate an output based on the weights sampled from the policy network 103. For example, if the training data 105 includes images, the binary neural network 104 may use the weights sampled at block 510 to process the images, and the output may correspond to an object the binary neural network 104 believes is depicted in each training image (e.g., a vehicle, person, cat, etc.). Doing so allows the binary neural network 104 to determine an error at block 540. Generally, the binary neural network 104 determines the error based on the output generated at block 530 for each training image and the label applied to each training image. For example, if a training image depicts a cat, and the binary neural network 104 returned an output indicating a dog is depicted in the image, the degree of error is computed based on a loss function.

At block 550, in a first backward training stage, the binary neural network 104 computes one or more gradients for each weight value sampled at block 510 via backpropagation of the binary neural network 104. In one embodiment, the binary neural network 104 applies Equation 9 above to compute each gradient. At block 560, one or more reward values are computed to update the θ values of the policy network 103 in a second backward training stage. In one embodiment, the binary neural network 104 applies Equation 10 above to compute each reward value. Furthermore, the weights of the hidden layers of the policy network 103 may be updated. At block 570, the values computed at block 560 are used to update the θ values and/or the weights of the hidden layers of the policy network 103. As stated, the θ values may include θ values for a posterior distribution one or more weights of the policy network 103, θ values for a posterior distribution for one or more layers of the policy network 103, θ values for a posterior distribution for one or more filters of the policy network 103, and θ values for a posterior distribution for one or more kernels of the policy network 103.

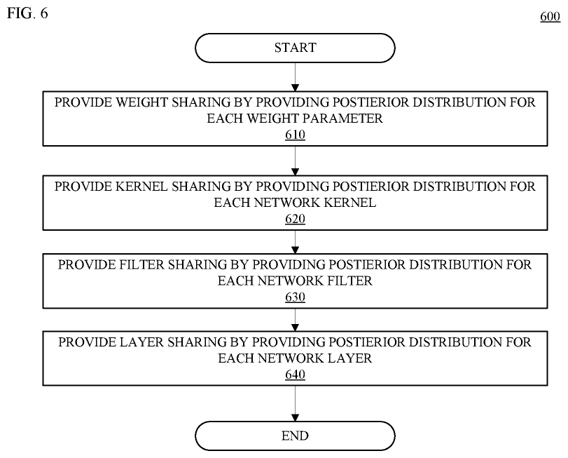

FIG. 6 illustrates an embodiment of a logic flow 600. The logic flow 600 may be representative of some or all of the operations executed by one or more embodiments described herein. For example, the some or all of the operations of the logic flow 600 may be implemented to provide different sharing mechanisms in the policy network 103. Embodiments are not limited in this context.

As shown, at block 610, a weight specific sharing policy may be applied by the policy network 103. In such an example, the policy network 103 may provide a posterior distribution for each parameter of the policy network 103 and/or a given BNN 104. The posterior distribution for each parameter may be conditioned on a respective θ value. At block 620, a kernel sharing policy may be applied by the policy network 103. In such an example, the policy network 103 may provide a posterior distribution for each kernel of the policy network 103 and/or a given BNN 104, where the posterior distribution for each kernel is conditioned on a respective θ value. At block 630, a filter sharing policy may be applied by the policy network 103 and/or a given BNN 104. In such an example, the policy network 103 may provide a posterior distribution for each filter of the policy network 103 and/or a given BNN 104, where the posterior distribution for each filter is conditioned on a respective θ value. At block 640, a layer sharing policy may be applied by the policy network 103. In such an example, the policy network 103 may provide a posterior distribution for each layer of the policy network 103 and/or a given BNN 104, where the posterior distribution for each kernel is conditioned on a respective θ value.

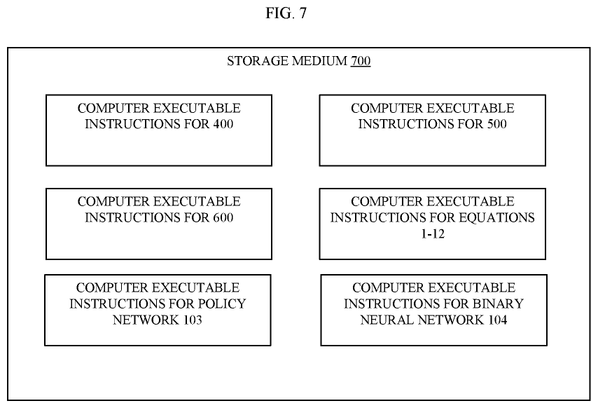

FIG. 7 illustrates an embodiment of a storage medium 700. Storage medium 700 may comprise any non-transitory computer-readable storage medium or machine-readable storage medium, such as an optical, magnetic, or semiconductor storage medium. In various embodiments, storage medium 700 may comprise an article of manufacture. In some embodiments, storage medium 700 may store computer-executable instructions, such as computer-executable instructions to implement one or more of logic flows or operations described herein, such as instructions 701, 702, 703 for logic flows 400, 500, 600 of FIGS. 4-6, respectively. The storage medium 700 may further store computer-executable instructions 705 for the policy network 103 (and components thereof), instructions 706, for binary neural networks 104 (and components thereof), and instructions 704 for Equations 1-12 described above. Furthermore, the computer-executable instructions for the policy network 103, binary neural networks 104, and/or Equations 1-12 may include instructions for generating and/or sampling from one or more posterior distributions conditioned on a respective θ value. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

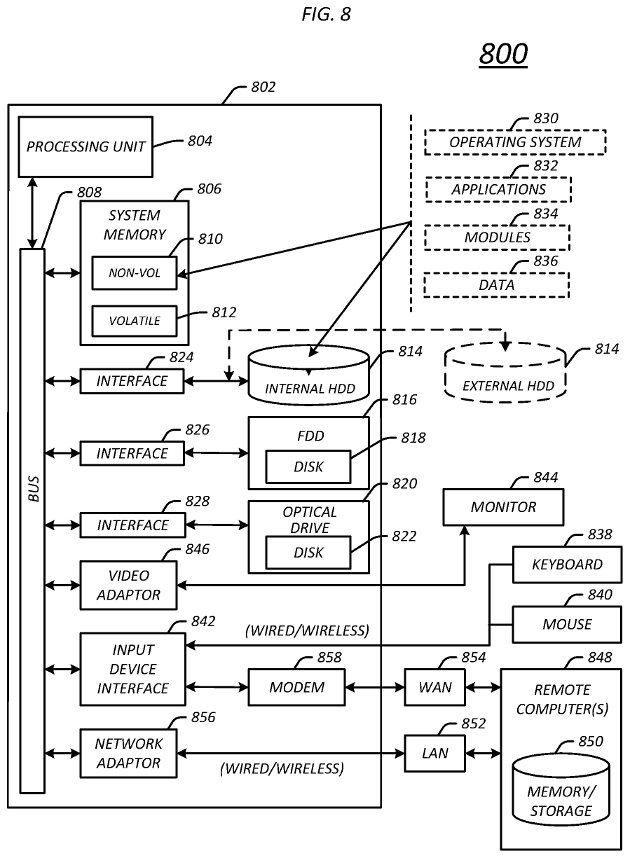

FIG. 8 illustrates an embodiment of an exemplary computing architecture 800 that may be suitable for implementing various embodiments as previously described. In various embodiments, the computing architecture 800 may comprise or be implemented as part of an electronic device. In some embodiments, the computing architecture 800 may be representative, for example, of a computer system that implements one or more components of the system 100. The embodiments are not limited in this context. More generally, the computing architecture 800 is configured to implement all logic, systems, logic flows, methods, apparatuses, and functionality described herein and with reference to FIGS. 1-7.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 (also referred to as a processor circuit) can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), bulk byte-addressable persistent memory (PMEM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a compact disc read-only memory (CD-ROM) or digital versatile disc (DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 100, including the policy network(s) 103, binary neural network(s) 104, training data 105, and/or other logic described herein.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. In various embodiments, one or more migrations may occur via the networked environment. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, ac, ay, etc.) to provide secure, reliable, fast wireless connectivity. A Wi-Fi network can be used to connect computers to each other, to the Internet, and to wire networks (which use IEEE 802.3-related media and functions).

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

The following examples pertain to further embodiments, from which numerous permutations and configurations will be apparent.

Example 1 is an apparatus, comprising a processor circuit; and memory storing instructions which when executed by the processor circuit cause the processor circuit to: receive a plurality of binary weight values for a binary neural network sampled from a policy neural network comprising a posterior distribution conditioned on a theta value; determine an error of a forward propagation of the binary neural network based on a training data and the received plurality of binary weight values; compute a respective gradient value for the plurality of binary weight values based on a backward propagation of the binary neural network; and update the theta value for the posterior distribution of the policy neural network using reward values computed based on the gradient values, the plurality of binary weight values, and a scaling factor.

Example 2 includes the subject matter of example 1, wherein the posterior distribution is shared by one or more of a layer of the policy neural network, a filter of the policy neural network, a kernel of the policy neural network, and a weight of the policy neural network.

Example 3 includes the subject matter of example 1, wherein the policy neural network comprises a plurality of posterior distributions, wherein each posterior distribution is conditioned on a respective theta value, wherein binary weight values for a first kernel of the binary neural network are sampled from a first posterior distribution of the plurality of posterior distributions conditioned on a first theta value, wherein binary weight values for a first filter of the binary neural network are sampled from a second posterior distribution of the plurality of posterior distributions conditioned on a second theta value, wherein binary weight values for a first layer of the binary neural network are sampled from a third posterior distribution of the plurality of posterior distributions conditioned on a third theta value.

Example 4 includes the subject matter of example 3, wherein the binary weight values for the first layer of the policy neural network are sampled from the first posterior distribution of the plurality of posterior distributions according to the following equation: hₗ¹=ƒ(s; θₗ¹).

Example 5 includes the subject matter of example 4, wherein the binary weight values for the first filter of the policy neural network are sampled from the second posterior distribution of the plurality of posterior distributions according to the following equation: hₗᵢ²=ƒ(hₗ¹; θₗᵢ²).

Example 6 includes the subject matter of example 5, wherein the binary weight values for the first kernel of the policy neural network are sampled from the third posterior distribution of the plurality of posterior distributions according to the following equation: hₗᵢₒ³=ƒ(hₗᵢ²; θₗᵢₒ³).

Example 7 includes the subject matter of example 6, wherein the binary weight values comprise a weight-specific probabilistic output determined according to the following equation: pₗᵢₒₖ=ƒ(hₗᵢₒ³; θₗᵢₒₖ⁴).

Example 8 includes the subject matter of example 7, wherein the binary weight values are sampled based on the following equations:

$$\{ \begin{matrix}P ( {\overline{w}}_{l i o k} = + 1 ) = {p}_{liok} \\ P {\overline{( w}}_{l i o k} = - 1 ) = - {p}_{liok}\end{matrix} \\ {p}_{l i o k 1} = f ( f ( f ( f ( s ; {θ}_{l}^{1} ) ; {θ}_{l i}^{2} ) ; {θ}_{l i o}^{3} ) ; {θ}_{l i o k 1}^{4} ) \\ {p}_{l i o k 2} = f ( f ( f ( f ( s ; {θ}_{l}^{1} ) ; {θ}_{l i}^{2} ) ; {θ}_{l i o}^{3} ) ; {θ}_{l i o k 2}^{4} ) .$$

Example 9 includes the subject matter of example 1, wherein the policy network comprises three hidden layers, wherein the three hidden layers of the policy network are not fully connected layers, wherein each hidden layer of the three hidden layers comprise one or more groups of neurons.

Example 10 includes the subject matter of example 1, the memory storing instructions which when executed by the processor circuit cause the processor circuit to: determine the error of the forward propagation of the binary neural network based on a loss function applied to an output generated by the binary neural network for the training data and a label applied to the training data.

Example 11 includes the subject matter of example 1, the memory storing instructions which when executed by the processor circuit cause the processor circuit to: compute the reward values based on the gradient values, the plurality of binary weight values, and the scaling factor; and update the theta value using a reinforcement algorithm and the computed reward values, wherein the gradient values are computed according to the following equation:

$${g}_{l i o k} = \frac{\partial Δ}{\partial {\overline{w}}_{liok}} ,$$

wherein the reward value is computed based on the following equation: rₗᵢₒₖ=μ(gₗᵢₒₖ)=−β×gₗᵢₒₖ×w̅ₗᵢₒₖ, wherein the reinforcement algorithm is based on an expected reward computed based on the following equation: J(θ)Σ_{l,i,o,k}E_{P(w}_{_{liok|θ}}₎rₗᵢₒₖ, wherein the reinforcement algorithm is based on an unbiased estimator based on the following equation: ∇J(θ)Σ_{l,i,o,k}(∇θ log P(w̅ₗᵢₒₖ|s, θ)×rₗᵢₒₖ).

Example 12 includes the subject matter of example 1, wherein an input layer of the policy neural network receives an initial state of the theta value as input, wherein a respective plurality of binary weight values are sampled from the policy neural network for each of a plurality of layers of the binary neural network.

Example 13 is a non-transitory computer-readable storage medium comprising instructions that when executed by a processor of a computing device, cause the processor to: receive a plurality of binary weight values for a binary neural network sampled from a policy neural network comprising a posterior distribution conditioned on a theta value; determine an error of a forward propagation of the binary neural network based on a training data and the received plurality of binary weight values; compute a respective gradient value for the plurality of binary weight values based on a backward propagation of the binary neural network; and update the theta value for the posterior distribution of the policy neural network using reward values computed based on the gradient values, the plurality of binary weight values, and a scaling factor.

Example 14 includes the subject matter of example 13, wherein the posterior distribution is shared by one or more of a layer of the policy neural network, a filter of the policy neural network, a kernel of the policy neural network, and a weight of the policy neural network.

Example 15 includes the subject matter of example 13, wherein the policy neural network comprises a plurality of posterior distributions, wherein each posterior distribution is conditioned on a respective theta value, wherein binary weight values for a first kernel of the binary neural network are sampled from a first posterior distribution of the plurality of posterior distributions conditioned on a first theta value, wherein binary weight values for a first filter of the binary neural network are sampled from a second posterior distribution of the plurality of posterior distributions conditioned on a second theta value, wherein binary weight values for a first layer of the binary neural network are sampled from a third posterior distribution of the plurality of posterior distributions conditioned on a third theta value.

Example 16 includes the subject matter of example 15, wherein the binary weight values for the first layer of the policy neural network are sampled from the first posterior distribution of the plurality of posterior distributions according to the following equation: hₗ¹=ƒ(s; θₗ¹).

Example 17 includes the subject matter of example 16, wherein the binary weight values for the first filter of the policy neural network are sampled from the second posterior distribution of the plurality of posterior distributions according to the following equation: hₗᵢ²=ƒ(hₗ¹; θₗᵢ²).

Example 18 includes the subject matter of example 17, wherein the binary weight values for the first kernel of the policy neural network are sampled from the third posterior distribution of the plurality of posterior distributions according to the following equation: hₗᵢₒ³=ƒ(hₗᵢ²; θₗᵢₒ³).

Example 19 includes the subject matter of example 18, wherein the binary weight values comprise a weight-specific probabilistic output determined according to the following equation: pₗᵢₒₖ=ƒ(hₗᵢₒ³; θₗᵢₒₖ⁴).

Example 20 includes the subject matter of example 19, wherein the binary weight values are sampled based on the following equations:

$$\{ \begin{matrix}P ( {\overline{w}}_{liok} = + 1 ) = {p}_{liok} \\ P {\overline{( w}}_{liok} = - 1 ) = - {p}_{liok}\end{matrix} \\ {p}_{liok 1} = f ( f ( f ( f ( s ; {θ}_{l}^{1} ) ; {θ}_{li}^{2} ) ; {θ}_{lio}^{3} ) ; {θ}_{liok 1}^{4} ) \\ {p}_{liok 2} = f ( f ( f ( f ( s ; {θ}_{l}^{1} ) ; {θ}_{li}^{2} ) ; {θ}_{lio}^{3} ) ; {θ}_{liok 2}^{4} ) .$$

Example 21 includes the subject matter of example 13, wherein the policy network comprises three hidden layers, wherein the three hidden layers of the policy network are not fully connected layers, wherein each hidden layer of the three hidden layers comprise one or more groups of neurons.

Example 22 includes the subject matter of example 13, comprising instructions which when executed by the processor circuit cause the processor circuit to: determine the error of the forward propagation of the binary neural network based on a loss function applied to an output generated by the binary neural network for the training data and a label applied to the training data.

Example 23 includes the subject matter of example 13, comprising instructions which when executed by the processor circuit cause the processor circuit to: compute the reward values based on the gradient values, the plurality of binary weight values, and the scaling factor; and update the theta value using a reinforcement algorithm and the computed reward values, wherein the gradient values are computed according to the following equation:

$${g}_{liok} = \frac{\partial Δ}{\partial {\overline{w}}_{liok}} ,$$

wherein the reward value is computed based on the following equation: rₗᵢₒₖ=μ(gₗᵢₒₖ)=−β×gₗᵢₒₖ×w̅ₗᵢₒₖ, wherein the reinforcement algorithm is based on an expected reward computed based on the following equation: J(θ)Σ_{l,i,o,k}E_{P(w}_{_{liok|θ}}₎rₗᵢₒₖ, wherein the reinforcement algorithm is based on an unbiased estimator based on the following equation: ∇J(θ)Σ_{l,i,o,k}(∇θ log P(w̅ₗᵢₒₖ|s, θ)×rₗᵢₒₖ).

Example 24 includes the subject matter of example 13, wherein an input layer of the policy neural network receives an initial state of the theta value as input, wherein a respective plurality of binary weight values are sampled from the policy neural network for each of a plurality of layers of the binary neural network.

Example 25 includes a method, comprising: receiving, by a binary neural network executing on a computer processor, a plurality of binary weight values sampled from a policy neural network comprising a posterior distribution conditioned on a theta value; determining an error of a forward propagation of the binary neural network based on a training data and the received plurality of binary weight values; computing a respective gradient value for the plurality of binary weight values based on a backward propagation of the binary neural network; and updating the theta value for the posterior distribution of the policy neural network using reward values computed based on the gradient values, the plurality of binary weight values, and a scaling factor.

Example 26 includes the subject matter of example 25, wherein the posterior distribution is shared by one or more of a layer of the policy neural network, a filter of the policy neural network, a kernel of the policy neural network, and a weight of the policy neural network.

Example 27 includes the subject matter of example 25, wherein the policy neural network comprises a plurality of posterior distributions, wherein each posterior distribution is conditioned on a respective theta value, wherein binary weight values for a first kernel of the binary neural network are sampled from a first posterior distribution of the plurality of posterior distributions conditioned on a first theta value, wherein binary weight values for a first filter of the binary neural network are sampled from a second posterior distribution of the plurality of posterior distributions conditioned on a second theta value, wherein binary weight values for a first layer of the binary neural network are sampled from a third posterior distribution of the plurality of posterior distributions conditioned on a third theta value.

Example 28 includes the subject matter of example 27, wherein the binary weight values for the first layer of the policy neural network are sampled from the first posterior distribution of the plurality of posterior distributions according to the following equation: hₗ¹=ƒ(s; θₗ¹).

Example 29 includes the subject matter of example 28, wherein the binary weight values for the first filter of the policy neural network are sampled from the second posterior distribution of the plurality of posterior distributions according to the following equation: hₗᵢ²=ƒ(hₗ¹; θₗᵢ²).

Example 30 includes the subject matter of example 29, wherein the binary weight values for the first kernel of the policy neural network are sampled from the third posterior distribution of the plurality of posterior distributions according to the following equation: hₗᵢₒ³=ƒ(hₗᵢ²; θₗᵢₒ³).

Example 31 includes the subject matter of example 30, wherein the binary weight values comprise a weight-specific probabilistic output determined according to the following equation: pₗᵢₒₖ=ƒ(hₗᵢₒ³; θₗᵢₒₖ⁴).

Example 32 includes the subject matter of example 31, wherein the binary weight values are sampled based on the following equations:

$$\{ \begin{matrix}P ( {\overline{w}}_{liok} = + 1 ) = {p}_{liok} \\ P {\overline{( w}}_{liok} = - 1 ) = - {p}_{liok}\end{matrix} \\ {p}_{liok 1} = f ( f ( f ( f ( s ; {θ}_{l}^{1} ) ; {θ}_{li}^{2} ) ; {θ}_{lio}^{3} ) ; {θ}_{liok 1}^{4} ) \\ {p}_{liok 2} = f ( f ( f ( f ( s ; {θ}_{l}^{1} ) ; {θ}_{li}^{2} ) ; {θ}_{lio}^{3} ) ; {θ}_{liok 2}^{4} ) .$$

Example 33 includes the subject matter of example 25, wherein the policy network comprises three hidden layers, wherein the three hidden layers of the policy network are not fully connected layers, wherein each hidden layer of the three hidden layers comprise one or more groups of neurons.

Example 34 includes the subject matter of example 25, further comprising: determining the error of the forward propagation of the binary neural network based on a loss function applied to an output generated by the binary neural network for the training data and a label applied to the training data.

Example 35 includes the subject matter of example 25, further comprising: computing the reward values based on the gradient values, the plurality of binary weight values, and the scaling factor; and updating the theta value using a reinforcement algorithm and the computed reward values, wherein the gradient values are computed according to the following equation:

$${g}_{l i o k} = \frac{\partial Δ}{\partial {\overline{w}}_{liok}} ,$$

wherein the reward value is computed based on the following equation: rₗᵢₒₖ=μ(gₗᵢₒₖ)=−β×gₗᵢₒₖ×w̅ₗᵢₒₖ, wherein the reinforcement algorithm is based on an expected reward computed based on the following equation: J(θ)Σ_{l,i,o,k}E_{P(w}_{_{liok|θ}}₎rₗᵢₒₖ, wherein the reinforcement algorithm is based on an unbiased estimator based on the following equation: ∇J(θ)Σ_{l,i,o,k}(∇θ log P(w̅ₗᵢₒₖ|s, θ)×rₗᵢₒₖ).

Example 36 includes the subject matter of example 25, wherein an input layer of the policy neural network receives an initial state of the theta value as input, wherein a respective plurality of binary weight values are sampled from the policy neural network for each of a plurality of layers of the binary neural network.

Example 37 includes An apparatus, comprising: means for receiving a plurality of binary weight values for a binary neural network sampled from a policy neural network comprising a posterior distribution conditioned on a theta value; means for determining an error of a forward propagation of the binary neural network based on a training data and the received plurality of binary weight values; means for computing a respective gradient value for the plurality of binary weight values based on a backward propagation of the binary neural network; and means for updating the theta value for the posterior distribution of the policy neural network using reward values computed based on the gradient values, the plurality of binary weight values, and a scaling factor.

Example 38 includes the subject matter of example 37, wherein the posterior distribution is shared by one or more of a layer of the policy neural network, a filter of the policy neural network, a kernel of the policy neural network, and a weight of the policy neural network.

Example 39 includes the subject matter of example 37, wherein the policy neural network comprises a plurality of posterior distributions, wherein each posterior distribution is conditioned on a respective theta value, wherein binary weight values for a first kernel of the binary neural network are sampled from a first posterior distribution of the plurality of posterior distributions conditioned on a first theta value, wherein binary weight values for a first filter of the binary neural network are sampled from a second posterior distribution of the plurality of posterior distributions conditioned on a second theta value, wherein binary weight values for a first layer of the binary neural network are sampled from a third posterior distribution of the plurality of posterior distributions conditioned on a third theta value.

Example 40 includes the subject matter of example 39, wherein the binary weight values for the first layer of the policy neural network are sampled from the first posterior distribution of the plurality of posterior distributions according to means for performing to the following equation: hₗ¹=ƒ(s; θₗ¹).

Example 41 includes the subject matter of example 40, wherein the binary weight values for the first filter of the policy neural network are sampled from the second posterior distribution of the plurality of posterior distributions according to means for performing to the following equation: hₗᵢ²=ƒ(hₗ¹; θₗᵢ²).

Example 42 includes the subject matter of example 41, wherein the binary weight values for the first kernel of the policy neural network are sampled from the third posterior distribution of the plurality of posterior distributions according to means for performing to the following equation: hₗᵢₒ³=ƒ(hₗᵢ²; θₗᵢₒ³).

Example 43 includes the subject matter of example 42, wherein the binary weight values comprise a weight-specific probabilistic output determined according to means for performing to the following equation: pₗᵢₒₖ=ƒ(hₗᵢₒ³; θₗᵢₒₖ⁴).

Example 44 includes the subject matter of example 43, wherein the binary weight values are sampled based on the means for performing the following equations:

$$\{ \begin{matrix}P ( {\overline{w}}_{liok} = + 1 ) = {p}_{liok} \\ P {\overline{( w}}_{liok} = - 1 ) = - {p}_{liok}\end{matrix} \\ {p}_{liok 1} = f ( f ( f ( f ( s ; {θ}_{l}^{1} ) ; {θ}_{li}^{2} ) ; {θ}_{lio}^{3} ) ; {θ}_{liok 1}^{4} ) \\ {p}_{liok 2} = f ( f ( f ( f ( s ; {θ}_{l}^{1} ) ; {θ}_{li}^{2} ) ; {θ}_{lio}^{3} ) ; {θ}_{liok 2}^{4} ) .$$

Example 45 includes the subject matter of example 37, wherein the policy network comprises three hidden layers, wherein the three hidden layers of the policy network are not fully connected layers, wherein each hidden layer of the three hidden layers comprise one or more groups of neurons.

Example 46 includes the subject matter of example 37, further comprising: determining the error of the forward propagation of the binary neural network based on a loss function applied to an output generated by the binary neural network for the training data and a label applied to the training data.

Example 47 includes the subject matter of example 37, further comprising: means for computing the reward values based on the gradient values, the plurality of binary weight values, and the scaling factor; and means for updating the theta value using a reinforcement algorithm and the computed reward values, wherein the gradient values are computed according to the following equation:

$${g}_{l i o k} = \frac{\partial Δ}{\partial {\overline{w}}_{liok}} ,$$

wherein the reward value is computed based on the following equation: rₗᵢₒₖ=μ(gₗᵢₒₖ)=−β×gₗᵢₒₖ×w̅ₗᵢₒₖ, wherein the reinforcement algorithm is based on an expected reward computed based on the following equation: J(θ)Σ_{l,i,o,k}E_{P(w}_{_{liok|θ}}₎rₗᵢₒₖ, (wherein the reinforcement algorithm is based on an unbiased estimator based on the following equation: ∇J(θ)Σ_{l,i,o,k}(∇θ log P(w̅ₗᵢₒₖ|s, θ)×rₗᵢₒₖ).

Example 48 includes the subject matter of example 37, wherein an input layer of the policy neural network receives an initial state of the theta value as input, wherein a respective plurality of binary weight values are sampled from the policy neural network for each of a plurality of layers of the binary neural network.

In addition, in the foregoing, various features are grouped together in a single example to streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1-20. (canceled)

21. An apparatus, comprising:
a processor circuit; and
memory storing instructions which when executed by the processor circuit cause the processor circuit to:
receive a plurality of binary weight values for a binary neural network sampled from a policy neural network comprising a posterior distribution conditioned on a theta value;
determine an error of a forward propagation of the binary neural network based on a training data and the received plurality of binary weight values;
compute a respective gradient value for the plurality of binary weight values based on a backward propagation of the binary neural network; and
update the theta value for the posterior distribution of the policy neural network using reward values computed based on the gradient values, the plurality of binary weight values, and a scaling factor.

22. The apparatus of claim 21, wherein the posterior distribution is shared by one or more of a layer of the policy neural network, a filter of the policy neural network, a kernel of the policy neural network, and a weight of the policy neural network.

23. The apparatus of claim 21, wherein the policy neural network comprises a plurality of posterior distributions, wherein each posterior distribution is conditioned on a respective theta value, wherein binary weight values for a first kernel of the binary neural network are sampled from a first posterior distribution of the plurality of posterior distributions conditioned on a first theta value, wherein binary weight values for a first filter of the binary neural network are sampled from a second posterior distribution of the plurality of posterior distributions conditioned on a second theta value, wherein binary weight values for a first layer of the binary neural network are sampled from a third posterior distribution of the plurality of posterior distributions conditioned on a third theta value.

24. The apparatus of claim 21, wherein the policy neural network comprises a plurality of hidden layers, wherein the hidden layers of the policy neural network are not fully connected layers, wherein each hidden layer comprises one or more groups of neurons.

25. The apparatus of claim 21, the memory storing instructions which when executed by the processor circuit cause the processor circuit to:
determine the error of the forward propagation of the binary neural network based on a loss function applied to an output generated by the binary neural network for the training data and a label applied to the training data.

26. The apparatus of claim 21, the memory storing instructions which when executed by the processor circuit cause the processor circuit to:
compute the reward values based on the gradient values, the plurality of binary weight values, and the scaling factor; and
update the theta value using a reinforcement algorithm, an expected reward value, and the computed reward values.

27. The apparatus of claim 21, wherein an input layer of the policy neural network receives an initial state of the theta value as input, wherein a respective plurality of binary weight values are sampled from the policy neural network for each of a plurality of layers of the binary neural network.

28. A non-transitory computer-readable storage medium comprising instructions that when executed by a processor of a computing device, cause the processor to:
receive a plurality of binary weight values for a binary neural network sampled from a policy neural network comprising a posterior distribution conditioned on a theta value;
determine an error of a forward propagation of the binary neural network based on a training data and the received plurality of binary weight values;
compute a respective gradient value for the plurality of binary weight values based on a backward propagation of the binary neural network; and
update the theta value for the posterior distribution of the policy neural network using reward values computed based on the gradient values, the plurality of binary weight values, and a scaling factor.

29. The non-transitory computer-readable storage medium of claim 28, wherein the posterior distribution is shared by one or more of a layer of the policy neural network, a filter of the policy neural network, a kernel of the policy neural network, and a weight of the policy neural network.

30. The non-transitory computer-readable storage medium of claim 28, wherein the policy neural network comprises a plurality of posterior distributions, wherein each posterior distribution is conditioned on a respective theta value, wherein binary weight values for a first kernel of the binary neural network are sampled from a first posterior distribution of the plurality of posterior distributions conditioned on a first theta value, wherein binary weight values for a first filter of the binary neural network are sampled from a second posterior distribution of the plurality of posterior distributions conditioned on a second theta value, wherein binary weight values for a first layer of the binary neural network are sampled from a third posterior distribution of the plurality of posterior distributions conditioned on a third theta value.

31. The non-transitory computer-readable storage medium of claim 28, wherein the policy neural network comprises a plurality of hidden layers, wherein the hidden layers of the policy neural network are not fully connected layers, wherein each hidden layer comprises one or more groups of neurons.

32. The non-transitory computer-readable storage medium of claim 28, comprising instructions which when executed by the processor cause the processor to:
determine the error of the forward propagation of the binary neural network based on a loss function applied to an output generated by the binary neural network for the training data and a label applied to the training data.

33. The non-transitory computer-readable storage medium of claim 28, comprising instructions which when executed by the processor cause the processor to:
compute the reward values based on the gradient values, the plurality of binary weight values, and the scaling factor; and
update the theta value using a reinforcement algorithm, an expected reward value, and the computed reward values.

34. The non-transitory computer-readable storage medium of claim 28, wherein an input layer of the policy neural network receives an initial state of the theta value as input, wherein a respective plurality of binary weight values are sampled from the policy neural network for each of a plurality of layers of the binary neural network.

35. A method, comprising:
receiving, by a binary neural network executing on a computer processor, a plurality of binary weight values sampled from a policy neural network comprising a posterior distribution conditioned on a theta value;
determining an error of a forward propagation of the binary neural network based on a training data and the received plurality of binary weight values;
computing a respective gradient value for the plurality of binary weight values based on a backward propagation of the binary neural network; and
updating the theta value for the posterior distribution of the policy neural network using reward values computed based on the gradient values, the plurality of binary weight values, and a scaling factor.

36. The method of claim 35, wherein the posterior distribution is shared by one or more of a layer of the policy neural network, a filter of the policy neural network, a kernel of the policy neural network, and a weight of the policy neural network.

37. The method of claim 35, wherein the policy neural network comprises a plurality of posterior distributions, wherein each posterior distribution is conditioned on a respective theta value, wherein binary weight values for a first kernel of the binary neural network are sampled from a first posterior distribution of the plurality of posterior distributions conditioned on a first theta value, wherein binary weight values for a first filter of the binary neural network are sampled from a second posterior distribution of the plurality of posterior distributions conditioned on a second theta value, wherein binary weight values for a first layer of the binary neural network are sampled from a third posterior distribution of the plurality of posterior distributions conditioned on a third theta value.

38. The method of claim 35, wherein the policy neural network comprises a plurality of hidden layers, wherein the hidden layers of the policy neural network are not fully connected layers, wherein each hidden layer comprises one or more groups of neurons.

39. The method of claim 35, further comprising:
determining the error of the forward propagation of the binary neural network based on a loss function applied to an output generated by the binary neural network for the training data and a label applied to the training data.

40. The method of claim 35, further comprising:
computing the reward values based on the gradient values, the plurality of binary weight values, and the scaling factor; and
updating the theta value using a reinforcement algorithm, an expected reward value, and the computed reward values.
